(19) United States
(12) Patent Application Publication
(10) Pub. No.: US 2017/0064690 A1
(43) Pub. Date: Mar. 2, 2017

(54) APPARATUS, SYSTEMS AND METHODS FOR USER EQUIPMENT (UE) COVERAGE ENHANCEMENT LEVEL UPDATE COMBINED WITH AN ABSENT TIME THAT HAS GENERATED CLOCK DRIFT

(71) Applicant: Sony Mobile Communications Inc., Tokyo (JP)

(72) Inventor: Lars Nord, Lund (SE)

(21) Appl. No.: 14/864,044

(22) Filed: Sep. 24, 2015

Related U.S. Application Data
(60) Provisional application No. 62/210,106, filed on Aug. 26, 2015.

(51) Int. Cl. H04W 72/04; H04W 4/00; H04W 76/04

(52) U.S. Cl. CPC H04W 72/048; H04W 76/046; H04W 4/005; H04W 76/048

(57) ABSTRACT

Apparatus, systems, and methods for updating the CE (Coverage Enhancement)-level of a User Terminal (UE) during an idle mode. While the UE is resynchronizing to a network after an absent time that has generated clock drift between the UE and the network, the UE evaluates the CE-level to determine that the CE-level has changed and, in response to determining that the CE-level has changed, determines a revised CE-level estimation. After the UE has re-synchronized, the UE updates the network with the revised CE-level estimation, which, in response to receiving the revised CE-level estimation, the network adjusts the CE-level of the UE based, at least in part, on the CE-level estimation. In specific embodiments, such updating of the network by the UE is achieved by using a TAU (Tracking Area Update) procedure that extend the request message with a CE-level estimation parameter provided by the UE (User Equipment)/mobile terminal.

### FIELD OF THE INVENTION

In general, embodiments of the invention relate to mobile network and, more particularly, providing for idle mode Coverage Enhancement (CE)-level update through implementation of Tracking Area Update (TAU) and extending the request message with a CE-level estimation parameter provided by the User Equipment (UE), based on CE-level estimation during resynchronization to the cellular network

### BACKGROUND

The 3GPP (3^{rd} Generation Partnership Project) has two separate tracks developing a new standard for the Internet of Things (IoT) of Machine Type communications, in which everyday objects are provided with network connectivity. The first track is an LTE (Long Term Evolution) track referred to as MTC (Machine Type Communications) and the second track is a GERAN (GSM (Global System for Mobile Communications)/EDGE (Enhanced Data-rates for Global Evolution) Radio Access Network) track referred to as CIoT (Cellular Internet of Things). Versions of both tracks address the need for range extension, specifically up to 20 dB (decibel) of range extension. 3GPP plans to achieve range extension with repetitions of transmission, referred to within 3GPP as Coverage Enhancement (CE), and plans to support various CE-levels (e.g. a granularity of 15 levels/4 bits).

Current methodologies for CE provide for the base station (i.e., eNB) and the UE (i.e., mobile terminal) to decide on CE-level while being in connected mode. Specifically, when the UE is entering the idle mode, the base station/eNB informs the Mobile Management Entity (MME) which CE-level was used during the connected mode. Thus, current methodologies assume that the CE-level that is stored by the MME will be the CE-level during paging (i.e., while the UE is in idle mode). However, current methodologies are silent as to how the CE-level stored in the MME can be updated during idle mode. Such updating of the CE-level during idle mode is necessary to insure that a MTC/CIoT device is successfully paged and, in the event the MTC/CIoT device has better radio conditions, the cellular network benefits from being able to save paging resources (i.e., CE may no longer be required.

Therefore, a need exists to develop apparatus, systems, methods and the like that provide for idle mode CE-level updating.

### BRIEF SUMMARY OF THE INVENTION

The following presents a simplified summary of one or more embodiments in order to provide a basic understanding of such embodiments. This summary is not an extensive overview of all contemplated embodiments, and is intended to neither identify key or critical elements of all embodiments, nor delineate the scope of any or all embodiments. Its sole purpose is to present some concepts of one or more embodiments in a simplified form as a prelude to the more detailed description that is presented later.

Embodiments of the present invention address the above needs and/or achieve other advantages by providing apparatus, systems, computer program products, methods or the like for idle mode CE (Coverage Enhancement)-level update. While the UE is resynchronizing to a network and after an absent time that has generated clock drift between the UE and the network, such as, but not limited to, an Extended Discontinuous Reception Cycle (eDRX), the UE evaluates the CE-level to determine that the CE-level has changed in comparison to a last-in-time synchronization and, in response to determining that the CE-level has changed, determines a revised CE-level estimation. After the UE has re-synchronized, the UE updates the network with the revised CE-level estimation, which, in response to receiving the revised CE-level estimation, the network adjusts the CE-level of the UE based, at least in part, on the CE-level estimation. Such idle mode CE-level update is achieved by using a TAU (Tracking Area Update) procedure and extend the request message with a CE-level estimation parameter provided by the UE (User Equipment)/mobile terminal. It should be noted that the embodiments discussed herein are equally applicable to both CIoT and MTC, as well as other radio technologies that would benefit from coverage enhancement.

A method for updating a Coverage Enhancement (CE)-level of a User Equipment (UE) during an idle mode defines first embodiments of the invention. The method includes, while the UE is resynchronizing to a network and after an absent time that has generated clock drift between the UE and the network, such as, but not limited to, an Extended Discontinuous Reception Cycle (eDRX), evaluating the CE-level to determine that the CE-level has changed in comparison to a last-in-time synchronization. The method further includes in response to determining that the CE-level has changed, determining a revised CE-level estimation, In addition, the method includes, after the UE has re-synchronized, updating the network with the revised CE-level estimation. In response to updating the network, the network adjusts the CE-level of the UE based, at least in part, on the CE-level estimation.

In specific embodiments of the method, updating the network further includes using a Tracking Area Update (TAU) procedure to update the network with the revised CE-level estimation. In such embodiments of the method, using the TAU procedure includes adding a CE-level estimation parameter in a TAU request message and communicating the TAU request message to the network.

In further specific embodiments of the method, evaluating the CE-level further includes evaluating the CE-level to determine that the CE-level has changed based on the UE moving in or out of a Coverage Enhancement mode.

In other specific embodiments of the method the steps of resynchronizing, evaluating, determining and updating occur prior to a next expected paging window.

In still further specific embodiments of the method, in response to updating the network, the network adjusts the CE-level of the UE based on the CE-level estimation and use factors associated with the UE.

A User Equipment (UE) apparatus for updating Coverage Enhancement (CE)-level during idle mode defines second embodiments of the invention. In specific embodiments the UE may comprise a Cellular Internet of Things (CIoT) device that supports both CE and an absent time that has generated clock drift between the UE and the network, such as, but not limited to, Extended Discontinuous Reception Cycle (eDRX), while in other embodiments the UE may comprise a Machine Type Communications (MTC) device that supports both CE and the absent time, e.g., eDRX. The UE apparatus includes a computing platform having a memory and a processor in communication with the memory. Further, the UE apparatus includes a CE-level estimation module that is stored in the memory and executable by the processor. The CE-level estimation module is configured to, while the UE is resynchronizing to a network and after an absent time that has generated clock drift between the UE and the network, evaluate the CE-level to determine that the CE-level has changed in comparison to a last-in-time synchronization and, in response to determining that the CE-level has changed, determine a revised CE-level estimation. Further, the CE-level estimation module is configured to, after the UE has re-synchronized, update the network with the revised CE-level estimation. In response to updating the network, the network adjusts the CE-level of the UE based, at least in part, on the CE-level estimation.

In specific embodiments of the UE apparatus, the CE-level estimation module is further configured to update the network by using a Tracking Area Update (TAU) procedure. Specifically, the CE-level estimation module is further configured to update the network by using the TAU procedure by adding a CE-level estimation parameter in a TAU request message and communicating the TAU request message to the network.

In other specific embodiments of the UE apparatus, the CE-level estimation module is further configured to evaluate the CE-level to determine that the CE-level has changed based on the UE moving in or out of a Coverage Enhancement mode.

In still further specific embodiments of the UE apparatus, the CE-level estimation module is further configured to perform resynchronizing, evaluating, determining and updating prior to a next expected paging window.

Moreover, in other specific embodiments of the UE apparatus, in response to updating the network, the network adjusts the CE-level of the UE based on the CE-level estimation and use factors associated with the UE.

A mobile communication network system for updating Coverage Enhancement (CE)-level during a UE's idle mode defines third embodiments of the invention. The system includes a user equipment (UE) apparatus including a first memory, a first processor in communication with the first memory and a CE-level estimation module stored in the first memory and executable by the first processor. The CE-level estimation module is configured to (i) while the UE is resynchronizing to a network and after an absent time that has generated clock drift between the UE and the network, evaluate the CE-level to determine that the CE-level has changed in comparison to a last-in-time synchronization, (ii) in response to determining that the CE-level has changed, determine a revised CE-level estimation, and (iii) after the UE has re-synchronized, update the network with the revised CE-level estimation. The system additionally includes a base station apparatus comprising a second memory, a second processor in communication with the memory and a CE-level update module that is stored in the second memory and executable by the second processor. The CE-level update module is configured to, in response to receiving the revised CE-level estimation, adjust the CE-level of the UE based, at least in part, on the CE-level estimation.

Thus, systems, apparatus, methods, and computer program products herein described in detail below provide for updating the CE (Coverage Enhancement)-level of a User Terminal (UE) during an idle mode. The UE may be a CIoT (Cellular Internet of Things) device, a MTC (Machine Type Communication) device or any other device supporting both CE and an absent time that has generated clock drift, such as, but not limited to, Extended Discontinuous Reception Cycle (eDRX). While the UE is resynchronizing to a network after an the absent time that generated clock drift between the UE and the network, the UE evaluates the CE-level to determine that the CE-level has changed in comparison to a last-in-time synchronization and, in response to determining that the CE-level has changed, determines a revised CE-level estimation. After the UE has re-synchronized, the UE updates the network with the revised CE-level estimation, which, in response to receiving the revised CE-level estimation, the network adjusts the CE-level of the UE based, at least in part, on the CE-level estimation. In specific embodiments, such updating of the network by the UE is achieved by using a TAU (Tracking Area Update) procedure that extend the request message with a CE-level estimation parameter provided by the UE (User Equipment)/mobile terminal.

### BRIEF DESCRIPTION OF THE DRAWINGS

Having thus described embodiments of the invention in general terms, reference will now be made to the accompanying drawings, where:

FIG. 1 is a block diagram of a system for updating Coverage Enhancement (CE)-level of a UE during idle mode, in accordance with embodiments of the present invention; and

FIG. 2 is a flow diagram of a method for updating CE-level of a UE during idle mode, in accordance with embodiments of the present invention.

### DETAILED DESCRIPTION OF EMBODIMENTS OF THE INVENTION

Embodiments of the present invention now may be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure may satisfy applicable legal requirements. Like numbers refer to like elements throughout.

A device may be referred to as a node or user equipment (“UE”). For the purpose of sending or receiving data, the device may connect to a wireless local area network (“WLAN”) or a mobile communication network (including evolution of 3GPP) LTE releases and 5^{th} Generation (“5G”) LTE releases). Any network described herein may have one or more base stations (“BS”) and/or access points (“AP”).

As discussed in detail herein, the present invention provides for updating the CE (Coverage Enhancement)-level of a User Terminal (UE) during an idle mode. The UE may be a CIoT (Cellular Internet of Things) device, a MTC (Machine Type Communication) device or any other device supporting both CE and an absent time that has generated clock drift between the UE and the network, such as, but not limited to, Extended Discontinuous Reception Cycle (eDRX). While the UE is resynchronizing to a network after an absent time that has generated clock drift between the UE and the network, the UE evaluates the CE-level to determine that the CE-level has changed in comparison to a last-in-time synchronization and, in response to determining that the CE-level has changed, determines a revised CE-level estimation. After the UE has re-synchronized, the UE updates the network with the revised CE-level estimation, which, in response to receiving the revised CE-level estimation, the network adjusts the CE-level of the UE based, at least in part, on the CE-level estimation. In specific embodiments, such updating of the network by the UE is achieved by using a TAU (Tracking Area Update) procedure that extend the request message with a CE-level estimation parameter provided by the UE (User Equipment)/mobile terminal.

An absent time, as used herein, refers to a period of time in which the UE is not required to listen for signals from network. Such signals include, but are not limited to, synchronization signals (e.g., primary synchronization signals (PSS) and secondary synchronization signals (SSS), system information (including Master Information Block (MIB) and System Information Block (SIB)), paging signals and the like. Additionally, unlike a conventional idle mode, during an absent time the UE is not required to perform any synchronization-related measurements and, as such, the UE and the network lose synchronization during an absent time. Applicant notes that an absent time, which may range up to about an hour in length, differs from a standard power save mode (PSM) in which the UE may be dormant up to 24 hours and is required to send the network a Tracking Area Update (TAU) message upon exiting the PSM.

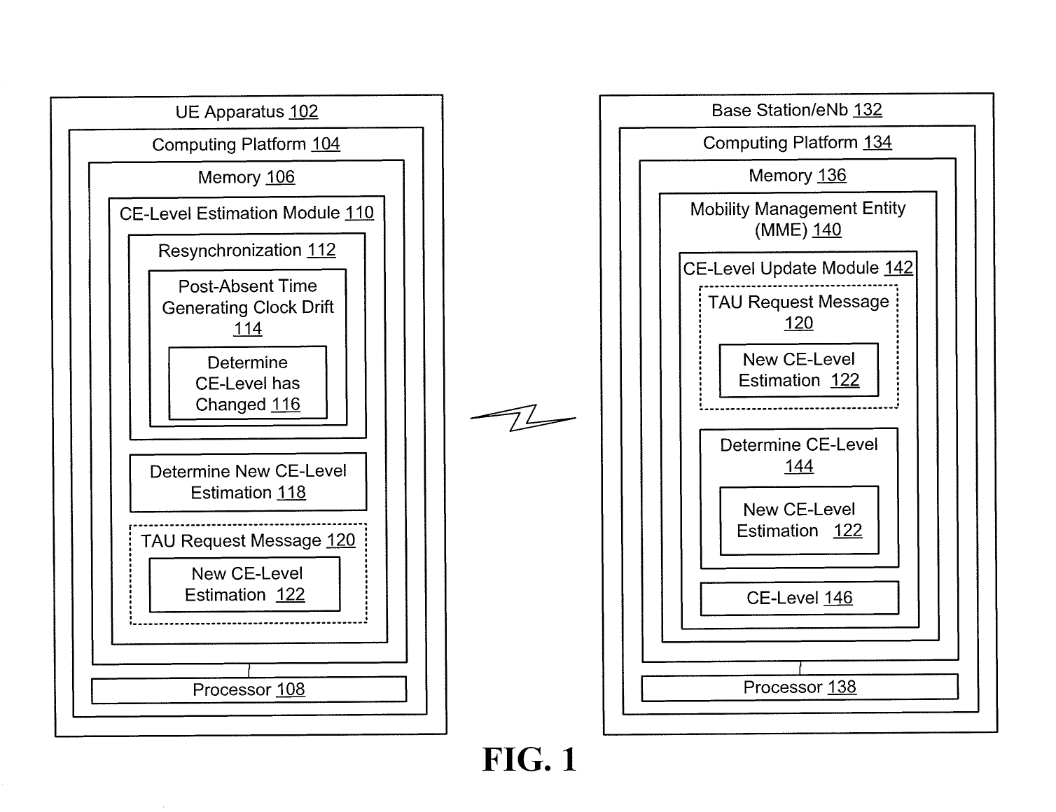

Referring to FIG. 1 a block diagram is presented of a system 100 for updating CE-level in a UE during idle mode, in accordance with embodiments of the present invention. The system includes an UE 202 and a base station/eNodeB 132. The UE 102 may be a CIoT device, a MTC device or any other device capable of supporting CE and an absent time that has generated clock drift between the UE and the network, such as, but not limited to, eDRX. The UE 102 includes a computing platform 104 having a memory 106 and a processor 108 in communication with the memory 106. The memory 106 stores CE-level estimation module 110 that is configured to determine a CE-level estimation during an idle mode and update the network as to the CE-level estimation, in accordance with embodiments of the present invention.

The CE-level estimation module 110 is configured to, while UE 102 is resynchronizing 112 to a network (e.g., base station 132) and after an absent time 114 that has generated clock drift between the UE and the network, such as but not limited to, an Extended Discontinuous Reception Cycle (eDRX), evaluate the CE-level to determine that the CE-level has changed 116 in comparison to a last-in-time synchronization. When eDRX is used by the UE apparatus 102 as the power save/idle mode, clock drift between UE apparatus 102 and the network (i.e., base station 132) requires a solution to ensure reliable paging. In addition, it is essential that the network (i.e., base station 132) use the correct CE-level when the UE apparatus 102 is operating in CE mode and eDRX mode. If the UE apparatus is not using the correct CE-level, the UE apparatus 102 will not be paged until the next time it wakes up (i.e., moves from idle mode to connected mode). Due to clock drift, the UE apparatus 102 needs to resynchronize 112 to the base station/eNodeB 132 after each eDRX cycle 114. In order to synchronize, the UE apparatus 102, which is operating in coverage enhancement mode, needs to capture and integrate several synchronization signals depending on the CE-level in order to decode the synchronization signal and re-synchronize 112 to the network/base station 132. During this re-synchronization 132, UE apparatus 102 evaluates the CE-level to determine if the CE-level has changed compared to a last-in-time synchronization of the UE apparatus to the network 102. UE apparatus 102 operating in CE mode is configured to detect if the CE-level has changed during the re-synchronization process.

In specific embodiments of the invention, the need to update the network of a CE-level change requires that the CE-level change be a significant change. In such embodiments of the invention, a significant change may be indicative of the UE apparatus 102 moving in to or out of coverage enhancement (CE) mode. Moving out of the CE mode means that UE apparatus can go back to normal paging without a need for repetitions (i.e., a possible need to lower the CE-level) and moving into the CE mode means that the network needs to use CE repetitions in order to successfully page the UE apparatus (i.e., a possible need to increase the CE-level).

CE-level estimation module 110 is further configured to, in response to determining that the CE-level has changed 116, determine a new/revised CE-level estimation 118 and, after the completion of the resynchronization 112 process, update the network as to the new/revised CE-level estimation 118. The new-revised CE-level estimation 118 reflects the need for the CE-level to change in order for the network to be able to successfully page the UE apparatus 102.

In order to minimize power consumption, the UE apparatus 102 has a desire to minimize the number of transmissions, as such, updating the network each time the CE-level has changed (i.e., each time a new/revised CE-level estimation is determined) is not an optimal process. In specific embodiments of the invention, the UE apparatus 102 is only required to perform cell based are updates (i.e., “paging area” updates, otherwise referred to herein as Tracking Area Update (TAU)) when the UE apparatus 102 moves outside the current “paging area”. Therefore, in order to minimize transmissions, in specific embodiments of the invention, when performing the TAU procedure, the CE-level estimation may also updated, as needed. In such embodiments of the invention, a TAU request message 120 may be configured to include a CE-level estimation parameter. In other specific embodiments of the invention, the TAU request message 120 that includes the CE-level estimation parameter may need to be repeated, according to the current CE-level provided to the UE apparatus 102, in order for the base station/eNodeB 132 to successfully receive the TAU request message 120.

In specific embodiments of the invention the CE-level estimation module 110 is configured to perform the CE-level estimation process (i.e., evaluating, determining and updating) prior to, but in conjunction with, a next expected paging window to allow the network time to adjust the CE-level, if needed.

The base station/132 includes a computing platform 134 having a memory 136 and a processor 138 in communication with the memory 136. The memory 106 may include Mobility Management Entity (MME) 140 which stores CE-level update module 142 that is configured to determine a CE-level 144 in response to receive the update from the UE apparatus 102 of the new/revised CE-level estimation 122. As previously discussed, in specific embodiments of the invention, the new revised CE-level estimation 122 may be included as a parameter within a TAU request message 120. The determination of the CE-level 144 is based, at least in part, on the new/revised CE-level estimation 122. In other embodiments of the invention, the determination of CE-level 144 takes into account other factors which may be specific to the implementation/use of the UE apparatus 102. Once the CE-level 146 is determined it is stored in MME 140 memory.

If the UE apparatus is in CE mode, then the network can decide to either (1) page the UE apparatus 102 using the CE-level 146 stored in the MME 140, or (2) page the UE apparatus 102 using a maximum CE-level to maximize the likelihood of successful paging (even if the radio conditions have changed). The decision to use the stored CE-level 146 or the maximum CE-level may be based on one or more of subscription priority, eDRX value, UE mobility history, current paging resource utilization and/or the like.

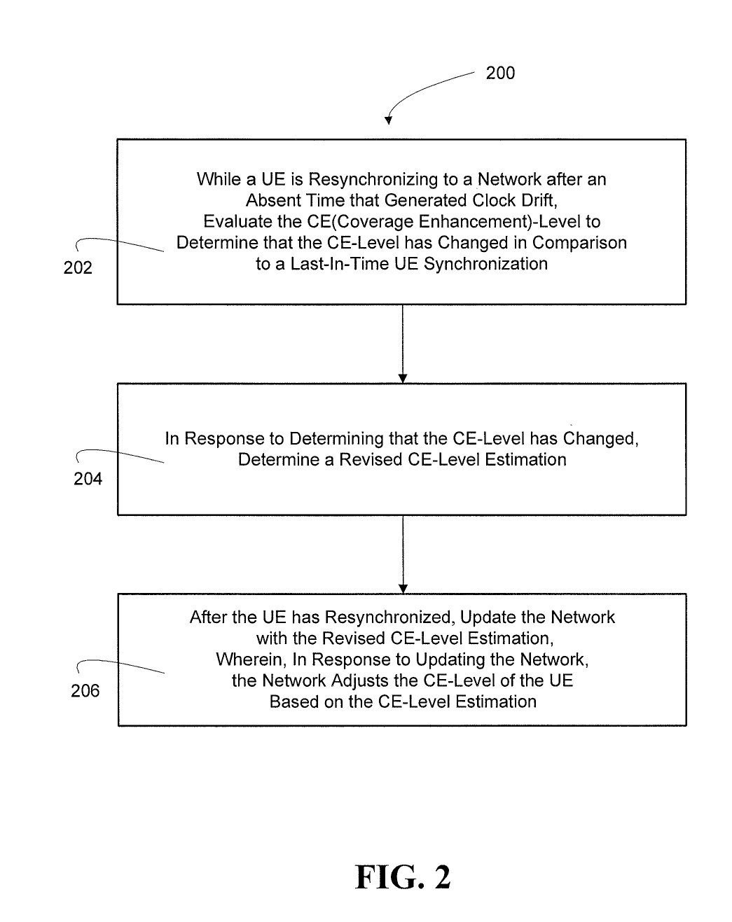

Referring to FIG. 2 a flow diagram is presented of a method 200 for updating CE-level in a UE during idle mode, in accordance with embodiments of the present invention. The UE may be a CIoT device, a MTC device or any other device supporting CE mode and eDRF. At Event 202, while the UE is resynchronizing to a network/base station and after an absent time that has generated clock drift between the UE and the network, such as, but not limited to, an Extended Discontinuous Reception Cycle (eDRX), CE-level is evaluated to determine if the CE-level has changed in comparison to the last-in-time synchronization. In specific embodiments of the invention, the CE-level is evaluated to determine if the CE-level has changed significantly, wherein “significantly” is defined by the UE moving in to or out of coverage enhancement mode.

At Event 204, in response to determining that the CE-level has changed, a new/revised CE-level estimation is determined and, at Event 206, after the resynchronization is completed, the network is updated with the revised CE-level estimation. In specific embodiments of the invention, the updating of the network occurs via Tracking Area Update (TAU) procedures, specifically, a CE-level estimation parameter is included within a TAU request message. Moreover, in other specific embodiments of the method, the overall updating process (i.e., resynchronization, evaluating, determining and updating) occur prior to a next expected paging window to allow the network time to adjust the CE-level, as needed.

In response to the network receiving the update, the network adjusts the CE-level of the UE based, at least in part, on the CE-level estimation. In specific embodiments of the invention, the CE-level may be adjusted to the CE-level estimations or in other events the CE-Level may be adjusted to another CE-level that takes into account the CE-level estimation and UE implementation factors. In other embodiments of the invention, the network can decide whether to page the UE using either the stored CE-level (determined based on the CE-level estimation and possibly other factors), or the maximum CE-level. Such determination may be based on one or more of subscription priority, eDRX value, UE mobility history, current paging resource utilization and/or the like.

Thus, systems, apparatus, methods, computer program products and the like described above provide for provide for updating the CE (Coverage Enhancement)-level of a User Terminal (UE) during an idle mode. The UE may be a CIoT (Cellular Internet of Things) device, a MTC (Machine Type Communication) device or any other device supporting both CE and an absent time that has generated clock drift between the UE and the network, such as, Extended Discontinuous Reception Cycle (eDRX). While the UE is resynchronizing to a network after an absent time that has generated clock drift between the UE and the network, the UE evaluates the CE-level to determine that the CE-level has changed and, in response to determining that the CE-level has changed, determines a revised CE-level estimation. The UE updates the network with the revised CE-level estimation, which, in response to receiving the revised CE-level estimation, the network adjusts the CE-level of the UE based, at least in part, on the CE-level estimation. In specific embodiments, such updating of the network by the UE is achieved by using a TAU (Tracking Area Update) procedure that extend the request message with a CE-level estimation parameter provided by the UE (User Equipment)/mobile terminal.

The invention is not limited to any particular types of devices of UEs, but rather may include CIoT devices, MTC devices or other non-CIoT or non-MTC devices that support CE and an absent time that has generated clock drift between the UE and the network. As used herein, a UE may also be referred to as a device, a system, or apparatus. Examples of UEs include any everyday object configured for network connectivity.

Each processor described herein generally includes circuitry for implementing audio, visual, and/or logic functions. For example, the processor may include a digital signal processor device, a microprocessor device, and various analog-to-digital converters, digital-to-analog converters, and other support circuits. Control and signal processing functions of the system in which the processor resides may be allocated between these devices according to their respective capabilities. The processor may also include functionality to operate one or more software programs based at least partially on computer-executable program code portions thereof, which may be stored, for example, in a memory.

Each memory may include any computer-readable medium. For example, memory may include volatile memory, such as volatile random access memory (“RAM”) having a cache area for the temporary storage of data. Memory may also include non-volatile memory, which may be embedded and/or may be removable. The non-volatile memory may additionally or alternatively include an EEPROM, flash memory, and/or the like. The memory may store any one or more of pieces of information and data used by the system in which it resides to implement the functions of that system.

The various features described with respect to any embodiments described herein are applicable to any of the other embodiments described herein. As used herein, the terms data and information may be used interchangeably. Although many embodiments of the present invention have just been described above, the present invention may be embodied in many different forms and should not be construed as limited to the embodiments set forth herein; rather, these embodiments are provided so that this disclosure will satisfy applicable legal requirements. Also, it will be understood that, where possible, any of the advantages, features, functions, devices, and/or operational aspects of any of the embodiments of the present invention described and/or contemplated herein may be included in any of the other embodiments of the present invention described and/or contemplated herein, and/or vice versa. In addition, where possible, any terms expressed in the singular form herein are meant to also include the plural form and/or vice versa, unless explicitly stated otherwise. As used herein, “at least one” shall mean “one or more” and these phrases are intended to be interchangeable. Accordingly, the terms “a” and/or “an” shall mean “at least one” or “one or more,” even though the phrase “one or more” or “at least one” is also used herein. Like numbers refer to like elements throughout.

As will be appreciated by one of ordinary skill in the art in view of this disclosure, the present invention may include and/or be embodied as an apparatus (including, for example, a system, machine, device, computer program product, and/or the like), as a method (including, for example, a business method, computer-implemented process, and/or the like), or as any combination of the foregoing. Accordingly, embodiments of the present invention may take the form of an entirely business method embodiment, an entirely software embodiment (including firmware, resident software, micro-code, stored procedures, etc.), an entirely hardware embodiment, or an embodiment combining business method, software, and hardware aspects that may generally be referred to herein as a “system.” Furthermore, embodiments of the present invention may take the form of a computer program product that includes a computer-readable storage medium having one or more computer-executable program code portions stored therein. As used herein, a processor, which may include one or more processors, may be “configured to” perform a certain function in a variety of ways, including, for example, by having one or more general-purpose circuits perform the function by executing one or more computer-executable program code portions embodied in a computer-readable medium, and/or by having one or more application-specific circuits perform the function.

It will be understood that any suitable computer-readable medium may be utilized. The computer-readable medium may include, but is not limited to, a non-transitory computer-readable medium, such as a tangible electronic, magnetic, optical, electromagnetic, infrared, and/or semiconductor system, device, and/or other apparatus. For example, in some embodiments, the non-transitory computer-readable medium includes a tangible medium such as a portable computer diskette, a hard disk, a random access memory (RAM), a read-only memory (“ROM”), an erasable programmable read-only memory (“EPROM” or Flash memory), a compact disc read-only memory (“CD-ROM”), and/or some other tangible optical and/or magnetic storage device. In other embodiments of the present invention, however, the computer-readable medium may be transitory, such as, for example, a propagation signal including computer-executable program code portions embodied therein.

One or more computer-executable program code portions for carrying out operations of the present invention may include object-oriented, scripted, and/or unscripted programming languages, such as, for example, Java, Perl, Smalltalk, C++, SAS, SQL, Python, Objective C, JavaScript, and/or the like. In some embodiments, the one or more computer-executable program code portions for carrying out operations of embodiments of the present invention are written in conventional procedural programming languages, such as the “C” programming languages and/or similar programming languages. The computer program code may alternatively or additionally be written in one or more multi-paradigm programming languages, such as, for example, F#.

Some embodiments of the present invention are described herein with reference to flowchart illustrations and/or block diagrams of apparatus and/or methods. It will be understood that each block included in the flowchart illustrations and/or block diagrams, and/or combinations of blocks included in the flowchart illustrations and/or block diagrams, may be implemented by one or more computer-executable program code portions. These one or more computer-executable program code portions may be provided to a processor of a general purpose computer, special purpose computer, and/or some other programmable information processing apparatus in order to produce a particular machine, such that the one or more computer-executable program code portions, which execute via the processor of the computer and/or other programmable information processing apparatus, create mechanisms for implementing the steps and/or functions represented by the flowchart(s) and/or block diagram block(s).

The one or more computer-executable program code portions may be stored in a transitory and/or non-transitory computer-readable medium (e.g., a memory, etc.) that can direct, instruct, and/or cause a computer and/or other programmable information processing apparatus to function in a particular manner, such that the computer-executable program code portions stored in the computer-readable medium produce an article of manufacture including instruction mechanisms which implement the steps and/or functions specified in the flowchart(s) and/or block diagram block(s).

The one or more computer-executable program code portions may also be loaded onto a computer and/or other programmable information processing apparatus to cause a series of operational steps to be performed on the computer and/or other programmable apparatus. In some embodiments, this produces a computer-implemented process such that the one or more computer-executable program code portions which execute on the computer and/or other programmable apparatus provide operational steps to implement the steps specified in the flowchart(s) and/or the functions specified in the block diagram block(s). Alternatively, computer-implemented steps may be combined with, and/or replaced with, operator- and/or human-implemented steps in order to carry out an embodiment of the present invention.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations, modifications, and combinations of the just described embodiments can be configured without departing from the scope and spirit of the invention. Therefore, it is to be understood that, within the scope of the appended claims, the invention may be practiced other than as specifically described herein.

What is claimed is:

1. A method for updating a Coverage Enhancement (CE)-level of a User Equipment (UE) during an idle mode, the method comprising:
while the UE is resynchronizing to a network and after an absent time that has generated clock drift between the UE and the network, evaluating the CE-level to determine that the CE-level has changed in comparison to a last-in-time synchronization;
in response to determining that the CE-level has changed, determining a revised CE-level estimation; and
after the UE has re-synchronized, updating the network with the revised CE-level estimation, wherein, in response to updating the network, the network adjusts the CE-level of the UE based, at least in part, on the CE-level estimation.

2. The method of claim 1 wherein updating the network further comprises using a Tracking Area Update (TAU) procedure to update the network with the revised CE-level estimation.

3. The method of claim 2, wherein using the TAU procedure to update the network with the revised CE-level estimation further comprises adding a CE-level estimation parameter in a TAU request message and communicating the TAU request message to the network.

4. The method of claim 1, wherein evaluating the CE-level further comprises evaluating the CE-level to determine that the CE-level has changed, wherein the change is based on the UE moving in or out of a Coverage Enhancement mode.

5. The method of claim 1, wherein the resynchronizing, evaluating, determining and updating occur prior to a next expected paging window.

6. The method of claim 1, wherein, in response to updating the network, the network adjusts the CE-level of the UE based on the CE-level estimation and use factors associated with the UE.

7. The method of claim 1, wherein the UE is further defined as a Cellular Internet of Things (CIoT) device.

8. The method of claim 1, wherein the UE is further defined as a Machine Type Communications (MTC) device.

9. A user equipment (UE) apparatus for updating Coverage Enhancement (CE)-level during idle mode, the apparatus comprising:
a computing platform including a memory and a processor in communication with the memory; and
a CE-level estimation module stored in the memory, executable by the processor, and configured to:
while the UE is resynchronizing to a network and after an absent time that has generated clock drift between the UE and the network, evaluate the CE-level to determine that the CE-level has changed in comparison to a last-in-time synchronization;
in response to determining that the CE-level has changed, determine a revised CE-level estimation; and
after the UE has re-synchronized, update the network with the revised CE-level estimation, wherein, in response to updating the network, the network adjusts the CE-level of the UE based, at least in part, on the CE-level estimation.

10. The UE apparatus of claim 9, wherein the CE-level estimation module is further configured to update the network by using a Tracking Area Update (TAU) procedure.

11. The UE apparatus of claim 10, wherein the CE-level estimation module is further configured to update the network by using the TAU procedure by adding a CE-level estimation parameter in a TAU request message and communicating the TAU request message to the network.

12. The UE apparatus of claim 9, wherein the CE-level estimation module is further configured to evaluate the CE-level to determine that the CE-level has changed, wherein the change is based on the UE moving in or out of a Coverage Enhancement mode.

13. The UE apparatus of claim 9, wherein the CE-level estimation module is further configured to perform resynchronizing, evaluating, determining and updating prior to a next expected paging window.

14. The UE apparatus of claim 9, wherein, in response to updating the network, the network adjusts the CE-level of the UE based on the CE-level estimation and use factors associated with the UE.

15. The UE apparatus of claim 9, wherein the UE apparatus is further defined as a Cellular Internet of Things (CIoT) device.

16. The UE apparatus of claim 9, wherein the UE apparatus is further defined as a Machine Type Communications (MTC) device.

17. A mobile communication network system for updating Coverage Enhancement (CE)-level during a UE's idle mode, the system comprising:
a user equipment (UE) apparatus comprising a first memory, a first processor in communication with the first memory and a CE-level estimation module stored in the first memory, executable by the first processor and configured to (i) while the UE is resynchronizing to a network after an absent time that has generated clock drift between the UE and the network, evaluate the CE-level to determine that the CE-level has changed in comparison to a last-in-time synchronization, (ii) in response to determining that the CE-level has changed, determine a revised CE-level estimation, and (iii) after the UE has re-synchronized, update the network with the revised CE-level estimation; and
a base station apparatus comprising a second memory, a second processor in communication with the memory and a CE-level update module stored in the second memory, executable by the second processor and configured to, in response to receiving the revised CE-level estimation, adjust the CE-level of the UE based, at least in part, on the CE-level estimation.

18. The system of claim 17, wherein the CE-level estimation module of the UE apparatus is further configured to update the network by using a Tracking Area Update (TAU) procedure by adding a CE-level estimation parameter in a TAU request message and communicating the TAU request to the base station apparatus.

19. The system of claim 17, wherein the CE-level estimation module of the UE apparatus is further configured to evaluate the CE-level to determine that the CE-level has changed, wherein the change is based on the UE moving in or out of a Coverage Enhancement mode.

20. The system of claim 17, wherein the CE-level estimation module is further configured to perform resynchronizing, evaluating, determining and updating prior to a next expected paging window.
